(19) United States
(12) Patent Application Publication
(10) Pub. No.: US 2023/0361660 A1
(43) Pub. Date: Nov. 9, 2023

(54) METHOD FOR PRODUCING A SKEWED STATOR

(71) Applicant: VALEO EAUTOMOTIVE GERMANY GmbH, Erlangen (DE)

(72) Inventors: Regina BACH, Bad Neustadt a.d. Saale (DE); Sebastian BEETZ, Bad Neustadt a.d. Saale (DE); Boris DOTZ, Bad Neustadt a.d. Saale (DE); Christian FINGER-ALBERT, Bad Neustadt a.d. Saale (DE); Carsten SIEPKER, Bad Neustadt a.d. Saale (DE); Sebastian WAIDER, Bad Neustadt a.d. Saale (DE)

(73) Assignee: VALEO EAUTOMOTIVE GERMANY GmbH, Erlangen (DE)

(21) Appl. No.: 18/247,003

(22) PCT Filed: Sep. 21, 2021
(86) PCT No.: PCT/EP2021/075873

§ 371 Date: Mar. 28, 2023

(30) Foreign Application Priority Data
Sep. 30, 2020 (DE) 10 2020 212 358.6

(51) Int. Cl. H02K 15/02; H02K 15/00; H02K 15/085; H02K 3/34

(52) U.S. Cl. CPC H02K 15/024; H02K 15/0025; H02K 15/085; H02K 3/345; H02K 2213/03; H02K 2201/06

(57) ABSTRACT

A method for producing a skewed stator having a stator winding composed of shaped conductors includes providing a stator core including a plurality of slots extending from a first end-face to an opposing second end-face and have a skew in the circumferential direction. An arrangement is provided having at least one shaped conductor having two straight leg portions oriented parallel to one another and connected by a connecting portion. Also included is inserting the arrangement into the stator core with the skewed slots at the first end-face by relative movement in the axial direction between the stator core and the arrangement, so that the leg portions of the at least one shaped conductor are bent as a result of the relative movement in such a way that the shape of the leg portions inserted into the stator core acquires a skew which corresponds to the skew of the slots.

The present invention relates to a method for producing a skewed stator, which has a stator winding composed of shaped conductors.

To avoid undesirable cogging torque and torque ripple in operation of an electrical machine, it is generally known to use a skewed stator and/or a skewed rotor.

CN 109 639 078 discloses a method for producing a stator arrangement of a motor with hairpin windings, comprising the following steps: provision of stator core with a skewed slot; provision of a plurality of hairpins with a square cross-sectional area; twisting of legs of the hairpins to match the spiral form of the skewed slots so that an angle of the legs corresponds to an angle of the slots; grouping of free ends of the legs of several twisted hairpins into a cage; insertion of the cage in the stator core by rotation; and electrical connection of the free ends into pairs so as to form a winding.

The invention is based on the object of indicating a simplified method for producing a skewed stator, the stator winding of which comprises shaped conductors.

According to the invention, this object is achieved by a method for producing a skewed stator, which has a stator winding composed of shaped conductors, comprising the following steps:
providing a stator core which comprises a plurality of slots which extend from a first end face of the stator core to an opposing second end face of the stator core and have a skew in the circumferential direction,
providing at least one arrangement having at least one shaped conductor which has two straight leg portions oriented parallel to one another and a connecting portion connecting the two leg portions,
inserting the arrangement, of which the shaped conductor comprises the straight leg portions, into the stator core with the skewed slots at the first end face by means of a relative movement in the axial direction between the stator core and the arrangement, so that the leg portions of the at least one shaped conductor are bent as a result of the relative movement in such a way that the shape of the leg portions inserted into the stator core acquires a skew which corresponds to the skew of the slots.

According to the method of the invention, a skewed stator is produced. A skewed stator is a stator in which the slots provided for the stator windings not only extend in the axial direction but also have a skew in the circumferential direction. These slots preferably run in a helix.

The stator furthermore comprises shaped conductors as stator windings. The shaped conductors have two leg portions and a connecting portion, which connects the leg portions, in particular electrically conductively. Such shaped connectors are in particular known as U-pin or hairpin windings. The leg portions in particular each comprise a free end and an end connected to the connecting portion.

To produce the skewed stator, the shaped conductors are provided such that their leg portions are initially straight. In particular, shaped conductors provided in this fashion are inserted into the stator core, which already has the skewed slots, so that the leg portions of the shaped conductors inserted into the stator core acquire a shape corresponding to the slots, in particular a helical shape following the helical slots.

In general, for production of the skewed stator, it is provided to insert the arrangement, of which the shaped conductor of which initially comprises the straight leg portions, into the stator core with the skewed slots at the first end face by means of a relative movement in the axial direction between the stator core and the arrangement, so that the leg portions of the at least one shaped conductor are bent as a result of the relative movement in such a way that the shape of the leg portions inserted into the stator core acquires a skew which corresponds to the skew of the slots. In particular, a relative movement occurs exclusively in the axial direction. Preferably, the stator core is unmoved and the arrangement is moved in the axial direction, in particular exclusively in the axial direction, relative to the unmoved stator core.

Thus in particular, a continuously skewed stator can be achieved with, in particular, maximum optimization of the reduction in cogging torque and torque ripple during operation of the electrical machine. Effectively, the advantages of a stator winding with shaped conductors are achieved, in particular simple production and the possibility of a high degree of automation in comparison with windings made of round wires. The stator achieved with the method according to the invention advantageously furthermore allows the use of an unskewed rotor, which quite substantially lowers the production costs of an electrical machine. Also, the method according to the invention advantageously allows omission of a bending of the leg portions in a separate method step before insertion into the slots, which simplifies the production process.

Before insertion of the arrangement, i.e. the straight leg portions of the shaped conductor, into the slots, in particular the prepared arrangement—of which the shaped conductors have the straight leg portions—is oriented relative to the stator core such that the straight leg portions are oriented parallel to the longitudinal extent or longitudinal axis of the stator core.

In particular, the free ends of the leg portions are inserted in the slots at the first end face of the stator core.

A shaped conductor, which may also be described as a hairpin conductor, is distinguished in particular in that it is formed from solid metal, in particular copper. Typically, the shaped conductors have a rectangular cross-section, in some cases rounded. The shaped conductor is preferably not limp. The leg portions of the shaped conductor may be rod-like. Preferably, the cross-sections of the leg portions are configured such that a predefined number of leg portions, for example maximum sixteen leg portions, preferably maximum twelve leg portions, particularly preferably maximum eight leg portions, radially layered inside a slot, fill at least 40%, in particular at least 60%, preferably at least 80% of the cross-sectional area of the slot.

It may furthermore be provided that an even number of leg portions are inserted in a respective slot, in particular at least two leg portions, preferably at least four leg portions, further preferably at least six leg portions, particularly preferably at least eight leg portions. In particular, with the method according to the invention, it is provided that—preferably directly—before the step of performing the relative movement, the leg portions and the slots run straight in the axial direction and only acquire the respective skew during the step of performing the relative movement. Typically, the leg portions and the connecting portion connecting them are formed in one piece.

Preferably, the stator core comprises a plurality of axially layered stator core elements, for example disc-like stator laminations or individual laminations. The stator core is in particular a laminated core. Preferably, the stator core elements of the stator core are connected together rotationally fixedly. The stator core elements may be connected together by substance bonding, in particular by welding, preferably laser welding. The stator core elements for example each have a thickness of 0.27 mm to 0.5 mm. The stator core elements are preferably electrically isolated from one another.

With the method according to the invention, the step of providing the stator core may in particular comprise the following substeps: providing a plurality of stator core elements; arranging the stator core elements such that passage openings of the stator core elements forming the slots of the stator core are skewed; and joining the stator core elements so that they are connected together rotationally fixedly.

As part of the arranging of the stator core elements, it may be provided that they are axially layered with an offset to one another forming the skew. Alternatively, it may be provided that the stator core elements are arranged axially layered one upon the other, so that the passage openings of the stator core elements forming the slots of the stator core extend straight in the axial direction. The skew may here be acquired in that the passage openings are collectively offset to one another. For this, it is possible that an offset tool, extending axially along all layered stator core elements, is inserted radially from the inside into one or more slots and pivoted so as to create the skew. Such an offset tool may also be designated a blade.

Preferably, the skew of the slots is helical. The helical or screw-thread skew is in particular distinguished by a constant pitch height and/or a skew angle which is constant in the axial direction.

With the method according to the invention, it is furthermore preferred if an axial opening of a respective slot at the first end face is situated at an angular position in the circumferential direction at which an axial opening of a directly adjacent slot at the second end face is situated. Thus, a skew around a slot pitch, which is particularly favourable electromagnetically, and for reduction of the cogging torque and torque ripple can be achieved.

In an advantageous embodiment of the method according to the invention, it may be provided that the arrangement comprises sufficient shaped conductors for the leg portions of the shaped conductors, radially layered, to fill, in particular completely fill, all slots of the stator core. Such an arrangement may also be designated a shaped conductor basket. Thus an arrangement is provided in which the shaped conductors are arranged according to a predefined winding pattern of the stator winding and in one insertion process completely fill the slots, or fill these so far that only individual additional shaped conductors need be inserted in order to connect the stator winding, for example to form phase connections and/or to form one or more star point connectors. One advantage of this embodiment is the rapid introduction of the shaped conductors into the stator core.

Alternatively, with the method according to the invention, it may be provided that multiple arrangements each of several shaped conductors are provided and inserted successively in the stator core, wherein the leg portions of the shaped conductors of the multiple arrangements, radially layered, fill all slots of the stator core. Such arrangements may also be designated as shaped conductor part baskets. Thus multiple arrangements are provided in which the shaped conductors are arranged according to a predefined winding pattern of the stator winding and in several insertion processes completely fill the slots, or fill these so far that only individual additional shaped conductors need be inserted in order to connect the stator winding, for example to form phase connections and/or to form one or more star point connectors.

A respective arrangement may comprise sufficient shaped conductors for the leg portions of the shaped conductors, radially layered, to fill the slots of the stator core in an angular region in the circumferential direction of maximum 180°, preferably maximum 120°, particularly preferably maximum 90°. To this extent, the leg portions may fill only one sector of the slots in the circumferential direction. Alternatively or additionally, a respective arrangement may comprise sufficient shaped conductors for the leg portions of the shaped conductors, radially layered in the slots, to fill maximum half, preferably maximum one third, particularly preferably maximum one quarter of the radial extent of a respective slot. Accordingly, such an arrangement may fill only part of the layers in the slots provided for the arrangement of the shaped conductors.

In principle, it is possible that the above-described arrangements overlap in the radial direction and/or in the circumferential direction. The use of multiple arrangements here allows even complex stator windings, which can only be created with difficulty by a single arrangement, to be easily handled and hence inserted in the slots in modular fashion.

In principle, with the method according to the invention, it is also possible that each arrangement comprises precisely one shaped conductor, so that these can be inserted individually and successively in the slots.

With the method according to the invention, it may be provided that the stator core is provided with electrically isolating slot liners, which are arranged in a respective slot of the stator core. Alternatively, as part of the method according to the invention, an electrically isolating slot liner may be inserted in a respective slot. A slot liner in particular means a device which extends over the entire axial extent of the slot and completely lines the slot in the circumferential direction in order to electrically isolate the inside of the slot from the stator core. Typically, such a liner is made of insulating paper. It is preferred if the material of the slot liner is selected such that, on insertion in the skewed slots, it follows the contour of the skew.

In an advantageous refinement of the method according to the invention, it may be provided that before carrying out the relative movement, a guide tool is arranged on the first end face of the stator core, wherein on performing the relative movement, a respective leg portion abuts on the guide tool before reaching the slot and is thereby bent so that the skew is formed. Thus, the leg portions are not bent directly on the stator core itself, but shortly before reaching the first end face, in order to avoid damage to the leg portions or the inner surface of the slots. The guide tool in particular has a higher mechanical strength than the shaped conductors do. Thus, a sufficiently high strength can be achieved to absorb the bending forces during bending.

Preferably, for each leg portion, the guide tool has a surface on which the leg portion abuts and is tangentially bent. Alternatively or in addition, it may be provided that, for each leg portion, the guide tool has a surface on which the leg portion abuts and is bent in the radial direction. The respective surface gives the leg portion its bend in the circumferential or radial direction during insertion so as to follow the skew of the slot. Preferably, the or a respective surface or the guide tool is made of metal, in particular steel.

The surfaces of the guide tool are preferably rounded and/or smoother than the surfaces of the stator core inside the slots. Such a very smooth and rounded surface allows the leg portions to slide more easily along the surfaces than along the stator core.

It is furthermore preferred if the or a respective surface slopes more steeply relative to the centre axis than a skew angle of the slots. Thus, any spring-back of the leg portions after bending can be compensated, so that the leg portions can easily be inserted into the slots.

Particularly advantageously, it may furthermore be provided that the guide tool is formed from a plurality of segments, wherein during the bending, the segments may be in a radially engaged position on the stator core and can be moved radially outward for removal of the guide tool. The segments may each have two radial protrusions, wherein the leg portions are guided from slot to slot alternately between the protrusions of one of the segments and between respective protrusions of two adjacent segments.

To avoid damage to the slot liners, it is particularly preferred if the relative movement is performed such that free ends of the leg portions of the slot liners do not touch. For this, the slot liners may be fixed by means of the guide tool.

With the method according to the invention, preferably shaped conductors are used in which the connecting portions are bent such that the leg portions of the shaped conductor create an offset by several slots in the circumferential direction and/or an offset by one or more layers in the radial direction. The provision of the at least one arrangement may comprise a bending of an elongate, electrically conductive rod so as to form the two parallel leg portions and/or the connecting portion, which forms the offset in the circumferential direction and/or the radial direction.

It is furthermore possible that the shaped conductors are formed during provision of the at least one arrangement by rotary draw bending, for example by means of a 3D bending device.

Following performing the relative movement, the following further step may be provided as part of the method according to the invention: bending of free ends of a respective leg portion at the second end face so that the free ends of different shaped conductors lie against one another. In addition, the following step may be provided: electrically conductive connection of the free ends lying against one another. Connection preferably takes place by a joining process, in particular by welding, preferably laser welding.

Further advantages and details of the present invention can be derived from the exemplary embodiments described below and by means of the drawings. The latter are schematic illustrations in which:

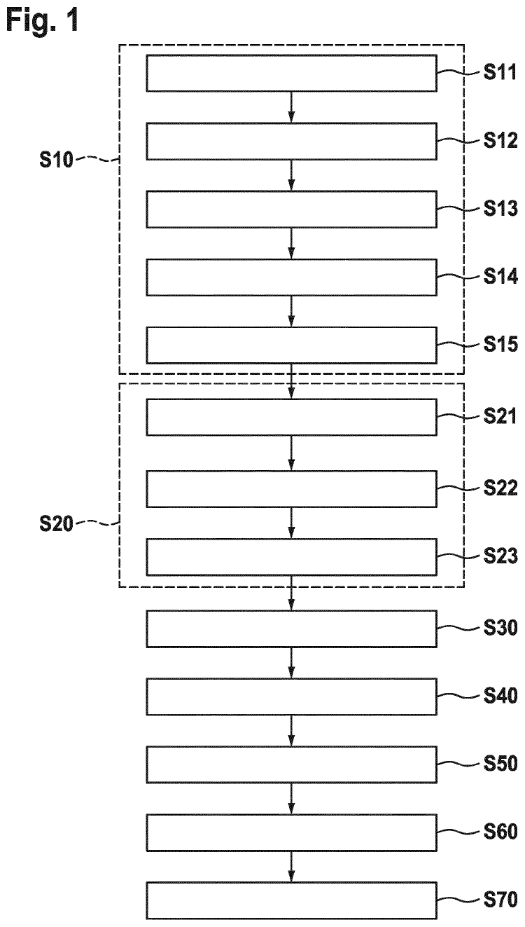

FIG. 1 shows a flowchart for an exemplary embodiment of the inventive method;

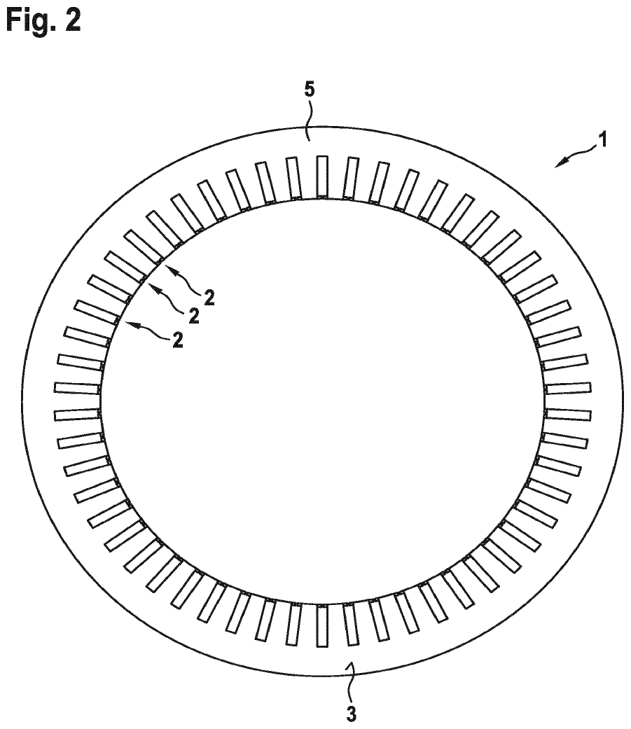

FIG. 2 shows a front view of a stator core used in the method;

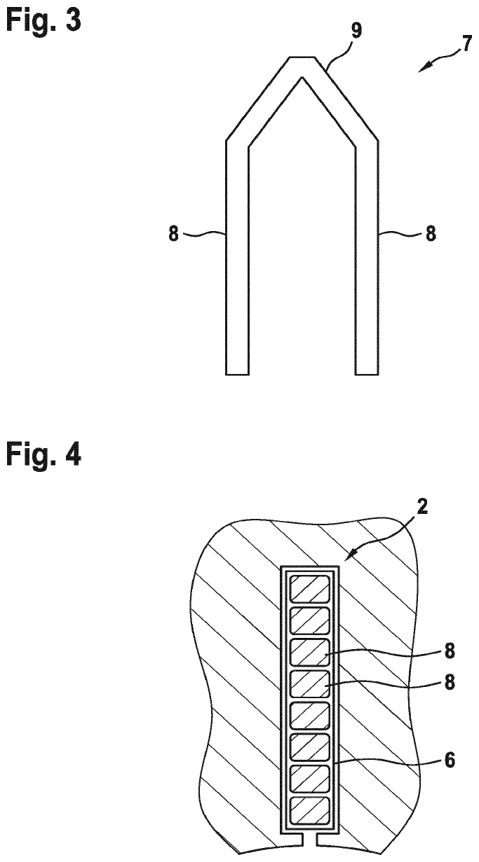

FIG. 3 shows a schematic sketch of a shaped conductor used in the method;

FIG. 4 shows a schematic sketch of a slot with leg portions of the shaped conductor arranged therein;

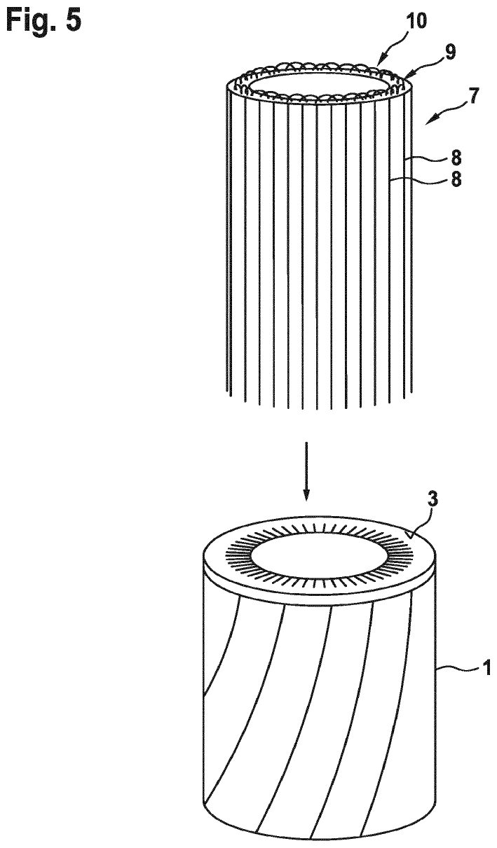

FIG. 5 shows a schematic sketch of a process of inserting an arrangement of shaped conductors in the stator core during the method;

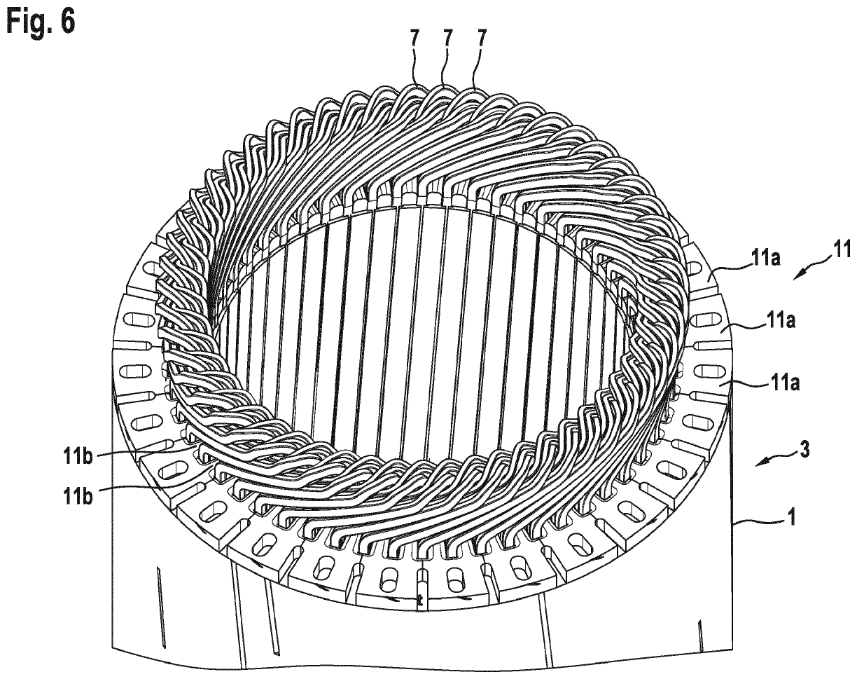

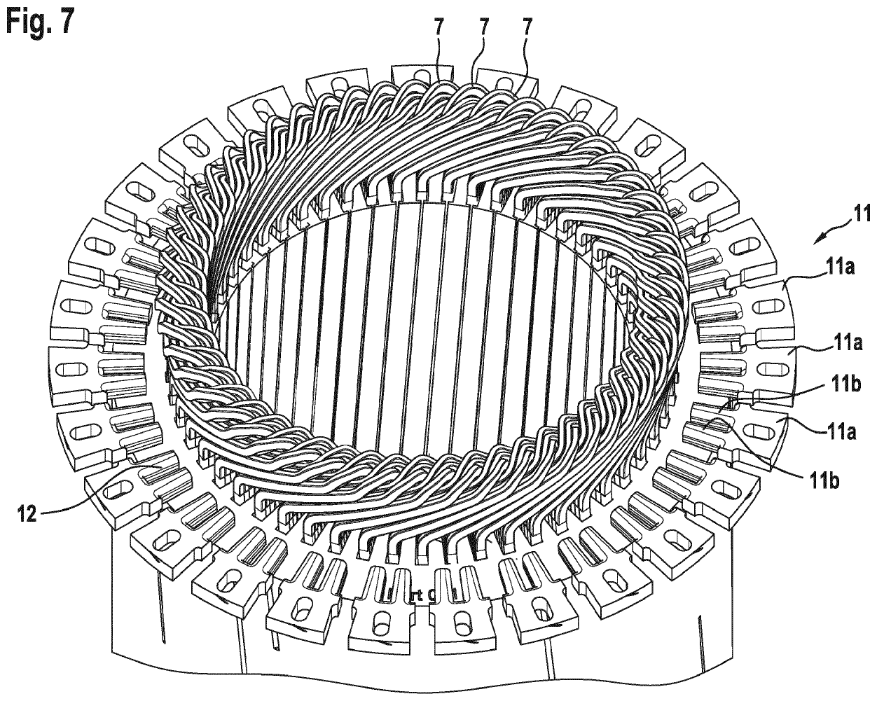

FIGS. 6 and 7 each show a perspective illustration of a guide tool used during the inventive method; and

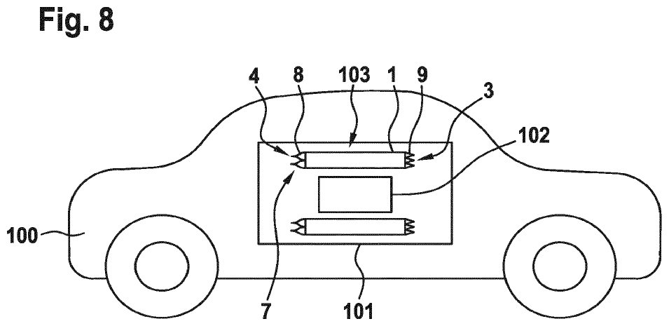

FIG. 8 shows a schematic sketch of an exemplary vehicle with an example of an electrical machine having a stator obtained with the inventive method.

FIG. 1 is a flow chart of an exemplary embodiment of an inventive method for production of a skewed stator.

The method comprises a first step S10 in which a stator core 1 is provided, which in particular is configured as a laminated core.

FIG. 2 is a front view of the stator core 1.

The stator core 1 in the present case comprises for example 54 slots 2 which extend from a first end face 3 shown in FIG. 2 to an opposite second end face 4 (see FIG. 3). The slots 2 have a helical skew around a slot pitch. Accordingly, an axial opening of a respective slot 2 at the first end face 3 is situated at an angular position in the circumferential direction at which an axial opening of a directly adjacent slot at the second end face 4 is situated (see FIG. 3).

The step S10 of providing the stator core 1 in this exemplary embodiment comprises five substeps S11 to S15:

In the first substep S11, a plurality of stator core elements 5 is provided which in particular are each formed as an individual lamination or stator lamination, e.g. with a thickness of 0.27 mm to 0.5 mm, and have passage openings for forming the slots 2. FIG. 2 shows the axially outermost stator core element 5. Typically, the stator core elements 5 are formed by punching. In the next substep S12, the stator core elements 5 are arranged axially layered one upon the other, so that the passage openings of the stator core elements 5 extend straight in the axial direction. In the next substep S13, the skew of the stator core 1 is created in that the passage openings are collectively offset to one another. For this, an offset tool extending along all layered stator core elements 5 is inserted radially from the inside into one or more slots 2 and pivoted to create the skew. In the next substep S14, the stator core elements 5 are joined together so that they are connected together rotationally fixedly. For this, several axial weld seams are created on the outside of the stator core 1 thus provided. This is done preferably by laser welding. In substep S15, an electrically isolating slot liner 6 (see FIG. 4) of insulating paper is inserted in each slot 2 and extends completely between the end faces 3, 4 in the axial direction and fully lines the slot 2 in the circumferential direction.

According to an alternative exemplary embodiment, step S13 is omitted if the stator core elements 5 are already axially layered with the offset to one another forming the skew.

FIG. 3 shows a schematic sketch of a shaped conductor 7 used in the method.

FIG. 4 shows a schematic sketch of a slot 2 with shaped conductors 7 received therein.

The shaped conductor 7 comprises two straight leg portions 8, which extend equidistantly, and a connecting portion 9, which connects the leg portions 7 electrically conductively. The connecting portion 8 is configured such that when the leg portions 7 are inserted in the slots 2, they are arranged in different slots 2 and in different radial layers within a respective slot 2, in particular by form fit. FIG. 4 shows that eight leg portions 8 in eight layers of a slot 2, which is lined by the slot liner 6, fill around 80% of the cross-sectional area of the slot 2. As shown, the leg portions 8 have a rounded rectangular cross-section. Each shaped conductor 7 is made of copper, wherein the leg portions 8 are formed integrally with the connecting portion 9.

FIG. 5 shows a schematic sketch of a process of inserting an arrangement 10 of shaped conductors 7 into the stator core 1 during the method.

In a step S20 of the method, the arrangement 10 is provided from a plurality of shaped conductors 7, wherein the leg portions are straight and oriented parallel to one another. The step S20 in this exemplary embodiment comprises three substeps S21 to S23:

In substep S21, a rod of copper is provided. In substep S22, this is bent so as to form firstly the connecting portion 9 and secondly the leg portions 8, which run straight and parallel to one another. The connecting portions 9 are bent such that the leg portions 8 of the shaped conductor 7 achieve an offset by several slots in the circumferential direction and an offset by one or more layers in the radial direction. The connecting portion 9 is formed by rotary draw bending, for example by means of a 3D bending device.

In substep S23, sufficient shaped conductors 7 for the arrangement 10 in the form of a shaped conductor basket are arranged so that the leg portions of the shaped conductors, radially layered, completely or almost completely fill all slots 2 of the stator core 1. In the arrangement 10, all connecting portions 9 lie at one axial end of the arrangement 10, and all free ends of the leg portions 8 lie at the other axial end of the arrangement 10.

FIGS. 6 and 7 each show a perspective illustration of a guide tool 11 used in the inventive method. The guide tool 11 is formed from a plurality of segments 11a, which correspond in number to half the number of slots 2 of the stator core 1. The segments 11a are in an engaged position in FIG. 6 and in a released position in FIG. 7. Each segment 11a has two radial protrusions 11b. In the present exemplary embodiment, the guide tool 11 is made for example of steel and has a higher mechanical strength than the shaped conductors 7.

In a step S30, the guide tool 11 is arranged on the first end face 3 of the stator core 1. For this, the segments 11a are arranged in their engaged position on the stator core 1 such that every second slot 2 sits between the protrusions 11b of a respective segment 11a and the other slots 2 between the protrusions 11b of two adjacent segments 11a. The guide tool 11 or a respective segment 11a here fixes the slot liners 6.

As FIG. 5 shows, in a step S40, a relative movement is performed in the axial direction between the stator core 1 and the arrangement 10. Only a linear movement in the axial direction of the arrangement 10 is performed, wherein the stator core 1 remains unmoved. The relative movement causes the insertion of the shaped conductors 7 into the slots 2. A respective leg portion 8 here abuts on a surface 12 (see FIG. 7) of the guide tool 11 and is bent tangentially. A respective surface 12 slopes more steeply relative to the centre axis of the stator core 1 than the skew angle of the slots 2, so the leg portions 8 can spring back after bending. The surfaces 12 are also formed smoother than the surfaces of the stator core 1 inside the slots 2, so that the leg portions 8 can slide easily over the surfaces 12. In some cases, the relative movement in the axial direction may be overlaid by a relative movement in the circumferential direction.

The relative movement is performed until the free ends of the leg portions 8 on the second end face 4 protrude out of the stator core 1. The relative movement takes place such that the free ends of the leg portions 8 do not touch the slot liners 6, in order to avoid damaging the slot liners 6. For this, as described above, the slot liners 6 are fixed by the guide tool 11. Also, the surface 12 is axially further out than the slot liners 6.

In further exemplary embodiments, it is possible that during the relative movement, the arrangement 10 remains unmoved and the stator core 1 is moved in the axial direction. It is furthermore possible that during the relative movement, both the arrangement 10 and also the stator core 1 are moved.

In a next step S50, the guide tool 11 is removed from the stator core 1. For this, as shown in FIG. 7, the segments 11a are moved radially outward.

In a next step S60, the free ends of the leg portions 8 at the second end face 4 are bent so that the free ends of two different leg portions lie against one another. In a next step S70, the free ends lying against one another are connected together electrically conductively by substance bonding by means of laser welding.

According to an alternative exemplary embodiment, in step S20, multiple arrangements 10 are provided or arranged in substep 23 as shaped conductor part baskets. A respective arrangement 10 here comprises sufficient shaped conductors 7 for their leg portions, radially layered, to fill slots 2 of the stator core 1 in a predefined angular region in the circumferential direction of maximum stator core elements 90° and/or, radially layered in the slots 2, to fill a quarter of the radial extent of a respective slot 2. These arrangements 10 are inserted successively in the slots 2 in step S40.

FIG. 8 shows a schematic sketch of a vehicle 100 with an electrical machine 101, which has a stator 103, produced using the above-described method.

An unskewed rotor 102 is mounted rotatably relative to the stator 103 inside the stator 103 of the electrical machine 101, which in the present case is configured as a permanently excited synchronous motor. It is evident that only connecting portions 9 of the shaped conductors 7 are situated on the first end face 3 of the stator core 1, and only the welded free ends of the leg portions 8 of the shaped conductors 7 are situated on the second end face 4 of the stator core 1.

The electrical machine 101 is designed to drive the vehicle 100. This is configured as a partly or fully electrically driven vehicle, for example a battery electric vehicle (BEV) or as a hybrid vehicle.

1. A method for producing a skewed stator which has a stator winding composed of shaped conductors, comprising the following steps:
providing a stator core which comprises a plurality of slots which extend from a first end face of the stator core to an opposing second end face of the stator core and have a skew in the circumferential direction,
providing at least one arrangement having at least one shaped conductor which has two straight leg portions oriented parallel to one another and a connecting portion connecting the two leg portions,
inserting the arrangement, of which the shaped conductor comprises the straight leg portions, into the stator core with the skewed slots at the first end face by means of a relative movement in the axial direction between the stator core and the arrangement, so that the leg portions of the at least one shaped conductor are bent as a result of the relative movement in such a way that the shape of the leg portions inserted into the stator core acquires a skew which corresponds to the skew of the slots.

2. The method as claimed in claim 1, wherein the skew of the slots is helical.

3. The method as claimed in claim 1, wherein the arrangement has as much shaped conductors as the leg portions of the shaped conductors, radially layered, fill all slots of the stator core.

4. The method as claimed in claim 1, wherein multiple arrangements are provided which are inserted successively into the stator core, wherein the leg portions of the shaped conductors of the multiple arrangements, radially layered, fill all slots of the stator core.

5. The method as claimed in claim 4, wherein a respective arrangement has as much shaped conductors as the leg portions of the shaped conductors
radially layered, fill the slots of the stator core in an angular region in the circumferential direction of maximum 180°, preferably maximum 120°, particularly preferably maximum 90°, and/or
radially layered in the slots, fill at most half, preferably at most a third, particularly preferably at most a quarter of the radial extent of a respective slot.

6. The method as claimed in claim 1, wherein before performing the relative movement, a guide tool is arranged on the first end face of the stator core, wherein during performing of the relative movement, a respective leg portion abuts on the guide tool before reaching the slot and is thereby bent so that the skew is formed.

7. The method as claimed in claim 6, wherein
for each leg portion, the guide tool has
a surface on which the leg portion abuts and is bent tangentially, and/or
a surface on which the leg portion abuts and is bent in the radial direction.

8. The method as claimed in claim 6, wherein the guide tool is formed from a plurality of segments, wherein during the bending, the segments are in a radially engaged position on the stator core and are moved radially outward for removal of the guide tool.

9. The method as claimed in claim 1, wherein
the stator core is provided with electrically isolating slot liners which are arranged in a respective slot of the stator core, or
an electrically isolating slot liner is inserted in the respective slot.

10. The method as claimed in claim 9, wherein the relative movement is performed such that free ends of the leg portions do not touch the slot liners.

11. The method as claimed in claim 2, wherein the arrangement has as much shaped conductors as the leg portions of the shaped conductors, radially layered, fill all slots of the stator core.

12. The method as claimed in claim 2, wherein multiple arrangements are provided which are inserted successively into the stator core, wherein the leg portions of the shaped conductors of the multiple arrangements, radially layered, fill all slots of the stator core.

13. The method as claimed in claim 2, wherein before performing the relative movement, a guide tool is arranged on the first end face of the stator core, wherein during performing of the relative movement, a respective leg portion abuts on the guide tool before reaching the slot and is thereby bent so that the skew is formed.

14. The method as claimed in claim 7, wherein the guide tool is formed from a plurality of segments, wherein during the bending, the segments are in a radially engaged position on the stator core and are moved radially outward for removal of the guide tool.

15. The method as claimed in claim 2, wherein
the stator core is provided with electrically isolating slot liners which are arranged in a respective slot of the stator core, or
an electrically isolating slot liner is inserted in the respective slot.

16. The method as claimed in claim 3, wherein multiple arrangements are provided which are inserted successively into the stator core, wherein the leg portions of the shaped conductors of the multiple arrangements, radially layered, fill all slots of the stator core.

17. The method as claimed in claim 3, wherein before performing the relative movement, a guide tool is arranged on the first end face of the stator core, wherein during performing of the relative movement, a respective leg portion abuts on the guide tool before reaching the slot and is thereby bent so that the skew is formed.

18. The method as claimed in claim 3, wherein
the stator core is provided with electrically isolating slot liners which are arranged in a respective slot of the stator core, or
an electrically isolating slot liner is inserted in the respective slot.

19. The method as claimed in claim 4, wherein before performing the relative movement, a guide tool is arranged on the first end face of the stator core, wherein during performing of the relative movement, a respective leg portion abuts on the guide tool before reaching the slot and is thereby bent so that the skew is formed.

20. The method as claimed in claim 4, wherein
the stator core is provided with electrically isolating slot liners which are arranged in a respective slot of the stator core, or
an electrically isolating slot liner is inserted in the respective slot.
